(19) United States
(12) Patent Application Publication
(10) Pub. No.: US 2007/0111625 A1
(43) Pub. Date: May 17, 2007

(54) Condensation dryer fabric

(75) Inventor: Antony Morton, West Yorkshire (GB)

Correspondence Address: GREENBLUM & BERNSTEIN, P.L.C., 1950 ROLAND CLARKE PLACE, RESTON, VA, 20191, US

(73) Assignee: VOITH FABRICS PATENT GMBH, HEIDENHEIM GERMANY (DE)

(21) Appl. No.: 10/532,208

(22) PCT Filed: Oct. 24, 2003
(86) PCT No.: PCT/GB03/04585

§ 371 Date: Apr. 28, 2005

(30) Foreign Application Priority Data
Oct. 24, 2002 (GB) 0224749.2
Dec. 27, 2002 (GB) 0230211.5

(51) Int. Cl. B32B 5/06; B32B 3/10; D04H 1/46; B32B 7/02; B32B 5/24

(52) U.S. Cl. 442/270; 428/212; 442/402; 428/131; 428/137; 442/221; 428/304.4; 442/275; 442/217

(57) ABSTRACT

A fabric for use in dynamic condensation drying apparatus comprises a single fabric comprising at least a core layer (22) of relatively large structure and large void size, and a paper support layer (21) of relatively fine structure and pore size, and optionally a cylinder side layer (23) of intermediate structure and pore size. A range of alternatives are shown, including the use of fibrous batts, woven fabrics, perforated membranes, sintered layers, chain-link fabrics, and honeycomb layers, as well as unitary woven or sintered fabrics incorporating the layers in a single structure.

### CROSS-REFERENCE TO RELATED APPLICATIONS

The present application is a U.S. National Stage of International Patent Application No. PCT/GB2003/004585 filed Oct. 24, 2003, and claims priority of Great Britain Patent Application No. 0224749.2 filed Oct. 24, 2002 and Great Britain Patent Application No. 0230211.5 filed Dec. 27, 2002.

### BACKGROUND OF THE INVENTION

1. Field of the Invention

This invention relates to a fabric for use in a so-called dynamic condensation drying apparatus or other similar condensation drying processes in the manufacture of paper and board.

2. Discussion of Background Information

A dynamic condensation drying apparatus involves the utilization of a heat source to generate water vapor within the wet web. This leads to an increase in vapor pressure and a thermodynamic drive for such moisture to leave the web.

The moisture is then condensed by cooling, the water then being retained by the fabric to avoid re-wetting of the web. In such dynamic condensation drying apparatus, a hot steam heated solid steel roll or belt is pressed against B moist paper web which is transported on a fine fabric. The fine fabric in turn lies immediately adjacent a coarse fabric. The coarse fabric is located next to a water-cooled solid steel or other composite impermeable belt.

The drying process begins as the paper web contacts the hot steel roll or belt, generating water vapor which passes through the fine fabric. This is collected as it condenses in the voids of the much cooler coarse fabric (as this is in contact with the water cooled belt). The temperature gradient between the two restraining elements, for example the hot and cold steel belts drives the drying equilibrium, since the more water removed from the gaseous state as condensate in the coarse fabric, the more water can be evaporated into vapor from the web. Air removal from the drying system and application of physical pressure to the web may also be a feature. The drying rate has been quoted as being typically 5-10 times higher than for cylinder drying, and the hot steel belt or roller may be used at 120°-180° C., and the cold steel or composite belt at 20°-90°.

The fine fabric serves to transmit uniform pressure to the paper web, as it is pressed between the two restraining elements; since a coarse fabric alone would mark the web. The coarse fabric is present to provide plenty of void volume in which water from the web can condense and be subsequently removed.

U.S. Pat. No. 6,397,493 (Voith-Sulzer) discloses one example of a dynamic condensation drying apparatus wherein a steel or composite belt seals the cooling chamber and the paper web is pressed against the heated cylinder by one or more fabrics.

U.S. Pat. No. 5,778,565 {Valmet} discloses a machine and process for carrying out the CONDEBELT (Registered Trade Mark) process, which consists of drying the web between two steel belts, one of which is heated and the other cooled. U.S. Pat. No. 5,706,587 and EP-A-0,727,521 disclose modifications thereof.

EP-A-0,962,588 and 0,962,589 disclose a two fabric arrangement, wherein a fine woven fabric is propelled on the paper side of a coarser fabric, the latter being modified by incorporation on the machine side face of additional finer cross-direction yarns in the spaces between the main cross-direction yarns to provide a fine woven surface against the cooled belt.

The term “fabric” as used above and hereinafter in practice refers to web support fabrics which are typically synthetic woven fabrics, although woven metal fabrics or hybrid metal/synthetic woven fabrics or non-woven fabrics, including membranes, may also be used.

The use of a fine and a coarse fabric as in the last example above however presents a number of problems notably:

a). The vapor passes through the fine top cloth and into the coarse cloth t1nd condenses, due to the fact that the coarse cloth is in contact with the cold steel surface. The coarse cloth is intended to retain the moisture, but there is potential for rewet to occur due to capillary action˜ of the fine top cloth drawing water back from the coarse cloth. The cold belt contacting side of the coarse cloth may be made finer by in- filling the weave with additional weft threads, while retaining a two-fabric arrangement (as in EP-A-0,962,588 above), which addressed the problem to some extent.

b). The fine structure of the top fabric means that it is not possible to incorporate a seam which can be joined on the paper machine using a pintle wire or any interconnecting technique, since the seam loops will be proud of the paper contacting surface of the fabric and will mark the web, since fine structures involve the use of thin fabrics. As a consequence, the top fabric has to be provided in endless form. To make an endless fabric involves either exceptionally wide and expensive weaving machinery, or the time consuming process of weaving a flat piece of fabric and then rendering it endless in a seaming machine, before delivery to the customer.

Highly complicated cantilevered machine structures are needed to install the top fabric in to such dryer systems. It may take several days to install the fabrics as compared to a number of hours if both of the fabrics were on machine joinable, for example by inserting a pintle wire through the fabric seaming loops or by effecting a join by other means.

c). The presence of two fabrics with different structures, which are simply laid one on top of the other, can lead to interference patterns when they are pressed between the belt and roll or between two belts. This is caused by the coincidence of weave knuckles in the upper and lower belts overlying each other. This interference can mark the web and/or lead to aggravated abrasion between the two fabrics. The latter is a particular problem where the two fabrics diverge at the end of the condenser belt dryer due to the difference in modulus between the two fabrics. The use of two fabrics also gives rise to problems such as increased wear and abrasion.

d). The presence of two fabrics holds additional complications in that each fabric requires its own set of return, guide and stretch rolls, as well as conditioning systems.

### SUMMARY OF THE INVENTION

The present invention overcomes the problems set out above so far as is possible by providing a single fabric for transport and dewatering of a paper web through a dynamic condensation drying apparatus as hereinbefore defined.

According to the invention, a dewatering fabric for use in dynamic condensation drying apparatus comprises a three layer fabric. The fabric preferably has a paper contacting surface layer, a core having a high void volume, and a machine side surface layer. The paper contacting surface layer preferably is relatively the finest of the three layers, that is it is comprised of closely spaced yarns or fibers of small diameter. The machine side surface layer is preferably of intermediate fineness, being composed of yarns or fibers of a larger diameter and more loosely spaced, than those of the paper contacting surface layer. The high void volume of the core may be provided for example by wide spacing of the constituent yarns or fibers, or by incorporation of a perforated sheet or membrane layer.

The invention makes possible an apparatus with a single dryer fabric for transporting the paper web through a dynamic condensation drying apparatus or similar installation, in place of the two fabrics heretofore considered necessary.

The finer surface of the paper contacting side serves to provide good support to the web, to allow for high heat transfer due to densely spaced contact points and to help prevent marking of the web. The opposite, fine surface which faces the cold belt is preferably not as fine as the web support surface, put is preferably sufficiently fine to encourage the condensed water to remain in the fabric without any tendency to be drawn back through the structure to cause web rewetting. To aid this, the core of the fabric may comprise a permeable structure containing relatively large pores with low capillary force.

Regions of the fabric may be treated so as to render them more, or less, hydrophilic to ensure preferential movement of moisture from the heated (web contacting) side to the cooled side.

The fabric may be endless or seamed, and if seamed is preferably capable of being joined on the machine, thereby overcoming many difficulties experienced at present.

The dryer fabric in accordance with the invention will be thicker than the fine fabric used heretofore in the condensation dryer apparatus and thus there will be no associated seaming problems as the seams need not lie proud of the surface.

The dryer fabric of the invention may comprise a core of woven base cloth, a single or composite perforated membrane or a spiral-link base cloth, having a batt of staple fibers needled to each face of the base cloth, or alternatively it may be filled with an open-celled foam, or a sintered or otherwise porous synthetic plastics material, which may be proud of the paper contacting side. Such structures can have the advantage of containing relatively large pores with low capillary forces.

The fibrous batt or porous medium may be coated with a resin such as an epoxy, phenoxy, fluoropolymer or silicone, and then perforated. The perforations may be carried out using laser, waterjet, mechanical punching or other cutting techniques or may result from the coating process, e.g. by coagulation chemistry or by transfer coating a reticular coating onto the batt or medium. The latter can give an optimum pore volume, surface tension, contact ratio and smoothness properties.

At least one layer of the dryer fabric may comprise a sintered structure formed from beads, fibers or other particles of thermoplastics, metal or the like, partially melted and fused together. The sintered structure may also contain chopped fibers and/or a textile reinforcement in the form of a woven fabric felt, non-woven fabric, membrane or yarn, at least partially encapsulated in the sintered structure.

At least one layer of the fabric may be microporous open cell foam coated structure.

The dryer fabric may comprise a laminate or sintered polymer, a coating or a fine staple batt layer, or a composite membrane supported by a spiral link or other open structure such as a coarse woven base cloth, with a further fine layer an the underside.

Preferably, the fabric is made from materials with high temperature and hydrolysis resistance, for example PPS, PEEK, polyamide, fluoropolymer, glass, metal PEN or PBM. Conventional dryer fabric materials may be used in parts of the fabric which are insulated to a certain extent from the hot felt or roll by the high temperature resistant material. These may include nylon, PET, PBT, PTT, PCTA or polyetheramides (such 56 Elf Atochem's PEBAX (Registered Trademark)).

The fabric according to the invention may also be used on conventional steam-heated dryer sections or on air-impingement dryer sections. A key requirement of a fabric for a dynamic condensation drying apparatus is to prevent rewetting of the paper web by water already expelled from the web into the fabric. Therefore hydrophobic materials are preferably used to make surface components of the fabric, although hydrophilic materials are of advantage in the lower regions away from the paper contacting surface, in order to provide good water storage capacity.

A further embodiment of the invention is based on the realization that the dryer or dewatering fabric may be comprised of zones of differing mean void volume, preferably also of differing void size or yarn diameter, rather than distinct layers; and also that the machine side surface zone of intermediate fineness, whilst highly desirable, can in some circumstances be omitted so that the machine side of the high void volume core may rest directly on the cold cylinder of the condensation drying apparatus.

A two zoned structure may for example comprise a woven core zone of relatively coarse warp and weft yarns, and on the paper side of the fabric, a woven zone of relatively fine warp and weft yarns. The layers are woven and interconnected by means of binder yarns in one weaving process, so giving a single woven entity. To achieve a three zoned structure, this woven entity may be modified by incorporation of a further ply of finer weft yarns, on the cylinder side of the core zone “below” the yarns of the core zone.

In a further embodiment, the zoned woven fabric may have a void volume, which increases from the fine paper side down through the fabric. This therefore would mean that the nominal or actual middle zone does not have the highest void volume. Such a zoned fabric would be of particular importance if coarse yarns were required in the bottom layer in order to give the fabric increased mechanical resistance and so longevity.

In a further embodiment, it may the case that a zoned fabric may have a middle and bottom layer that are of similar or identical void volume.

The weaves could be the same in all layers or different in at least one layer. Examples of possible weaves are plaint twill, satins etc with 16,20,24,28,32 end 40 shaft weaves especially preferred. In addition, the number of md and cd yarns per cm, as well as their diameters have a large number of possible variations. Also, the yarns need not be necessarily round, they could be square, rectangular, ovate, bi-nodal etc in order to modify the openness, smoothness, caliper etc. Also, weaving with md and/or cod yarns in one or more layers as paired yarns is also a possible technique to modify void volume, whilst minimising the effect on caliper. Also, it is possible that the fabrics could be calendered to give increased surface contact area and smoothness. Any of the zones can be made of any desired number of plies.

Examples of possible alternative multizone structures include a two layer fabric comprising a relatively fine woven layer laminated to a perforated membrane of synthetic plastics material, or resin impregnated fibrous material. The perforations of the membrane may be preferably tapered, for example frustoconical, with their wider ends adjacent the fine woven layer, and their narrower ends opening from the surface of the membrane at the cooling cylinder side. The tapering perforations may comprise two notional zones of different void volume, the wide ends forming a core zone of greater void volume and the narrower ends a cylinder side zone of lower void volume, despite the fact that there is no precise demarcation between the zones. Alternatively the perforations may be stepped, giving a quasi-three layer fabric.

Another possible embodiment of the fabric comprises a structure of sintered particles, bonded together by fusion over contact zones, after having been subjected to heating sufficient to soften their outer layers to the point of tackiness, and to pressure sufficient to ensure area rather than point contact between the particles, but low enough to leave significant void space in interstices between the particles. The sintered particle structure is preferably made as a single unit and comprising a core zone of relatively large particles with large spaces remaining between them, and an outer zone on the paper side with relatively fine particles defining a paper contacting surface, and also preferably a further zone on the cylinder side of relatively fine particles (possibly coarser than those on the paper side) which define a cylinder contacting surface, these zones created by laying down particles of differing sizes as the structure is built up.

The sintered particle structure may, or may not, incorporate reinforcing fibers.

Some embodiments of the invention will now be described by way of example with reference to the accompanying drawings, wherein:-

### BRIEF DESCRIPTION OF THE DRAWINGS

FIG. 1 is a diagram showing a fragmentary cross-section of a part of a condensation drying apparatus;

FIG. 2 is a sectional view of a first embodiment of dryer fabric according to the invention;

FIGS. 3, 4, 5, 7, 8 and 9 are sectional views of further embodiments of dryer fabric according to the invention;

FIG. 6 is a fragment perspective view of a yet further embodiment of dryer fabric according to the invention;

FIG. 10 is a structural diagram looking in the machine direction showing the weave structure of a first fabric embodying a modified structure according to the invention;

FIG. 11 is a diagram of the same fabric showing the weave structure looking in the cross-machine direction;

FIG. 12 is a cross-sectional view of a composite fabric in accordance with the invention, and

FIG. 13 is a cross-sectional view of a further embodiment of fabric according to the invention comprising a structure of sintered polymeric particles.

### DETAILED DESCRIPTION OF THE PRESENT INVENTION

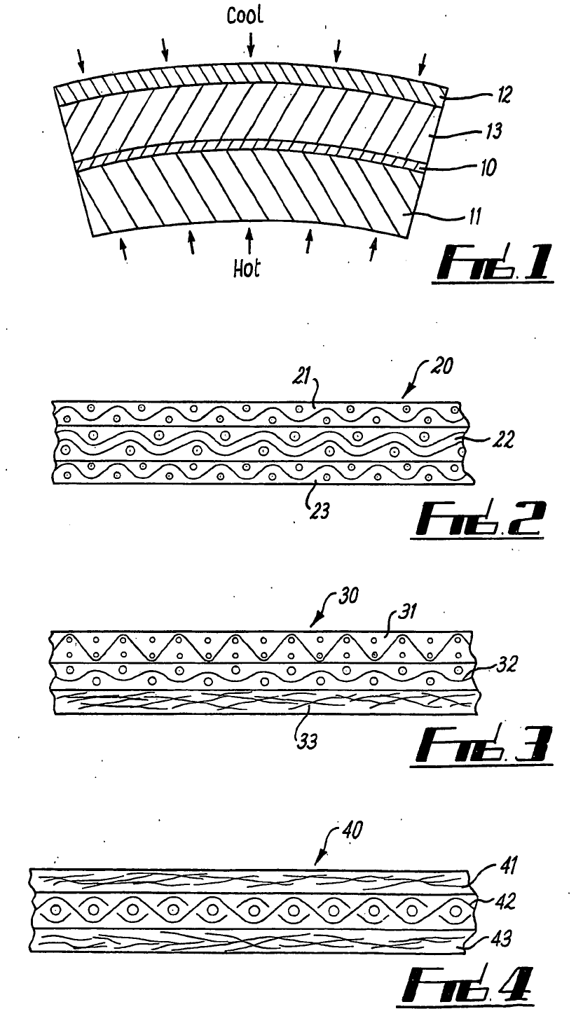

FIG. 1 is a diagrammatic sectional view of a roll in a dynamic condensation drying apparatus. This is a magnified view of part of the shell of the roll with superposed dryer and carrier belts, with the curvature exaggerated. The outer wall of the roll comprises a shell or steel surface 11, which is heated from within the roll. A paper web 10 is passed over the roll in contact with the heated shell 11, with a drier fabric 13 pressing if thereon. The dryer fabric also serves to transport the paper web 10, and to absorb moisture driven from the web 10. Belt 12 is exposed to lower temperatures on its outer-side. This may be by contact with ambient air, forced ventilation, or actively refrigerated air, or more preferably a reservoir of cooled water, which is sealed by belt 12. The heated surface of cylinder 11 is between the range 120° C.-180° C., whilst the belt 12 is maintained in the range 20° C.-90° C., that is below boiling point so that condensation can take place.

In the remaining figures several examples of dryer fabrics 13 are shown in diagrammatic cross sections.

FIG. 2 illustrates a preferred embodiment of a dryer fabric in a dynamic condensation drying apparatus. The fabric 20 consists of laminated, superposed, needled together, or interlaced woven fabric layers, comprising a fine mesh woven layer 21 on the paper contacting side of the fabric (i.e. towards the heated roll), a core comprised of a coarse mesh woven layer 22, and a further woven layer 23 on the reverse side of the fabric, contacting the impermeable belt 12, and towards the cooled side of the apparatus. The layer 23 is normally less fine than layer 21, but significantly less coarse than the core layer 22.

A further embodiment is illustrated in FIG. 3. In this, a fabric 30, comprising a fine two-ply woven fabric 31 is provided on the paper contacting side of the composite fabric. This is supported by a core 32 of a coarser weave base cloth, with a fine fiber baft 33 on the reverse side of the fabric, to contact the cooled impermeable belt 12.

FIG. 4 shows a yet further embodiment of fabric 40 wherein a batt 41 of finer fibers is provided on the paper contacting face of a core comprising a woven support fabric 42. A further batt 43, predominantly of coarser and higher density fibers is provided on the cooled impermeable belt side of the fabric 40 (the lower side in the drawing).

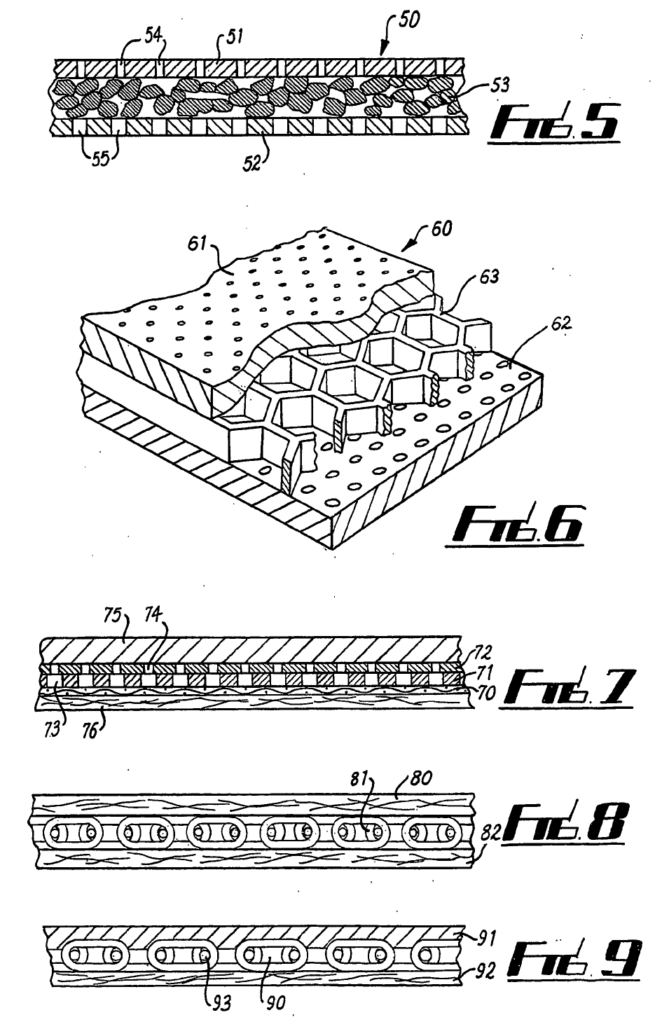

In FIG. 5, the fabric 50, which includes a paper contacting membrane layer 51 and a cooled belt contacting side membrane layer 52. The membrane layers 51, 52 are separated by at least one core layer 53. Membrane layer 51 is provided with relatively fine perforations or pores 54 of relatively small opening which are also relatively closely spaced. The membrane layer 52 includes perforations 55 which are of larger opening than the perforations in the layer 51. The percentage of void spaces in the two membrane layers may be equal or approximately equal, or the percentage of void space in the layer 52 may be greater than that in layer 51.

The core layer 53 has a higher percentage of void space than either of the membrane layers and includes a network of interconnecting passageways to assist the through passage of water. In the embodiment shown, this is achieved by making the layer 53 from a mass of particles of thermoplastic material which are firmly fused under pressure to adhere at their tangential surfaces and at the same time leaving considerable space between the particles.

The particles may be generally spherical, oblate, cylindrical (e.g. formed by closely chopping yarns or fibers) or irregular.

The above observations concerning the incidence of void space in the outer and inner layers of the various dryer fabric structures is applicable to all the particularly described embodiments of the invention mentioned both above and hereinafter.

FIG. 6 shows an example of fabric 60 with a foraminous honeycombed structure 63, comprising a top membrane layer 61 with small apertures, and a bottom membrane layer 62, with large apertures and the honeycomb membrane 63 sandwiched therebetween.

The top layer 61 is the paper web contacting layer, and the bottom layer 62 contacts the cooled impermeable belt 12.

In FIG. 7, a fabric is shown comprising more than three layers, and this comprises a base cloth 70 of a coarse woven fabric which provides sufficient void volume and supports a composite membrane comprised of two or more superimposed layers 71; 72; each layer 71,72 has differently sized and spaced apertures 73, 74. The layer having the greater void spaces preferably adjacent the base cloth 70. The composite membrane carries a layer 75 of sintered thermoplastic particles which form the paper contacting layer. A further layer 76, comprising a non-woven batt of fine fibers is provided below the base cloth 70. In FIG. 8, the fabric comprises a fibrous batt 80 of staple fibers on its paper side is needled into a spiral link base cloth 81, and a second batt 82 of fine fibers below the base cloth 81. In variations of this embodiment, either or both of the batts may be surfaced with a resin such as an epoxy, phenoxy, fluoropolymer or a silicone and/or the link base cloth filled with a foam plastics material.

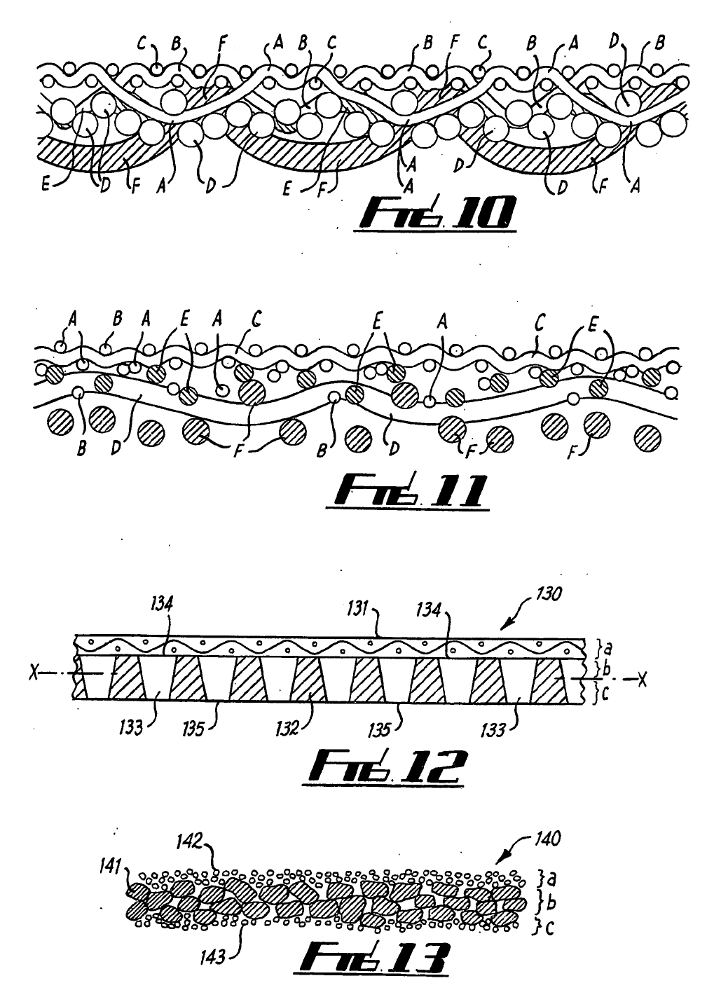

In FIG. 9, a spiral link fabric core 90 has plastics coating 91 on the paper contacting side, this coating penetrating about a third of the way into the spiral link fabric e.g. to the level of the cross-machine direction hinge yarns, which hold the links together. In this embodiment a fine fibrous batt layer 92 is provided on the belt face of the link fabric.

FIGS. 10 and 11 are sectional views of a single, three zoned, woven fabric in accordance with the invention, FIG. 10 looking in the machine direction and FIG. 11 in the cross direction. The fabric consists of a fine, upper paper contacting surface (i) consisting of fine diameter md and cd binder yarns woven together. The cd binder yarns A and B interweave with md yarns C in a plain weave, whilst also binding with md yarns of the middle zone (iii). It may also be the case that the upper layer also consists of standard cd yarns, in addition to the pairs of binder yarns, which simply form a plain weave with md yarns C. The middle zone is made up of md yarns D, having a greater diameter, interwoven with cd yarns E, also having an increased diameter, to give a fabric middle layer having a significantly larger void volume than the upper, paper contacting surface (i). The lower zone (iii) is made up of thicker cd yarns F, which interweave with md yarns D of the middle layer. Due to the difference in CD yarn weaves and the CD yarn diameters in layers (ii) and (iii), layer (iii) probably has the larger void volume.

FIG. 12 is a sectional view of a composite fabric 130 in accordance with the invention the fabric 130 comprises an upper paper contacting layer, formed by a fine woven material 131 such as sail cloth, which is bonded by adhesive or thermal bonding for example to a composite membrane 132. The composite membrane 132 is of a suitable plastics material, or a resin bonded non-woven material, or reinforcing fibers encapsulated in a resin matrix. The membrane 132 is perforated with tapering apertures 133 which may be frustoconical (with circular end openings) or pyramidal (with square or rectangular end openings). The wider ends 134 of the apertures 133 are at the upper face of the membrane 132 where it abuts the woven material 131, whilst the narrower ends 135 of the aperture 133 are at the lower face of the membrane 132. Whilst the material 131, which defines a fine pored upper zone a also has a discrete and separate layer. The membrane 132, by reason of the taper of the apertures 133 provides an upper core zone b with high void space and a lower zone c of reduced void space.

There is no well defined boundary between the zones, and the boundary may be taken to be along a line such as X-X in FIG. 12 where for example the void cross-section falls below 50% of that at the upper face of the membrane.

FIG. 13 illustrates a further embodiment of the fabric according to the invention wherein the fabric 140 is comprised of a layer of polymeric particles which have been thermally bonded at their contacting surfaces by the action of a degree of pressure to produce sufficient contact area, but not to impair porosity, and heating to above the softening point of the polymer; in other words the particles have been sintered to form a sheet. The particles comprise a core zone b of relatively large particles 141, which provide for relatively large void spaces therebetween. An upper zone a on the paper contacting side of the fabric 140 is made up of relatively small particles 142, and a lower zone on the cooling side of the fabric of particles 143 which are smaller than the large particles 141, but may nevertheless be larger than particles 142. The layer of polymeric particles comprises a single sintered or thermally bonded structure which falls into three zones of different particle size and porosity. The structure may include reinforcing fibers which may be included in the thermal bonding, serving by their length to link a plurality of particles. The larger particles 142 may be finely divided polymer sheet or fibrous material, whilst the finer particles such as 141 or 143 may be microspheres or miorobeads of the kind used in syntactic plastic compositions.

In the above embodiments, the upper fine zone, whether provided by finer yarns or particles, provides a smooth surface for paper contact. The core zone b in each case has relatively high void space and allows drainage of moisture away from the paper. The cooling belt side finer zone c may as in the case of FIG. 1 be absent, or as in FIG. 3 be indistinctly demarcated from the core zone b.

The FIG. 13 embodiment may be modified by providing a gradient of particle size inwardly from the surfaces of the fabric towards the core zone b. This would help to eliminate migration of fine particles from the outer zones a or c into the voids of zone b thus avoiding obstruction of the voids, and the sintered structure could just comprise two of the zones, for example (a) comprising the finer particles 141 and (b) comprising the coarser particles 142.

The paper contacting surface of the above described embodiments can be rendered microporous by coating with a fluoropolymer, silicone, epoxy or phenoxy resin, which may be coagulated to form a microporous skin, or a reticulated coating may be transferred onto the batt or other surface medium.

The fabrics of the invention provide void space within the belt; and also help to prevent rewetting of the web by provision of a fine layer in contact with the cooled condensing belt 12, drawing moisture away from the web by capillary action.

1. A dewatering fabric for use in dynamic condensation drying apparatus comprising a multi-layer fabric.

2. A dewatering fabric according to claim 1, wherein the fabric comprises a paper contacting surface layer and a core having a high void volume, the core having a machine side surface.

3. A dewatering fabric according to claim 2, wherein a third layer comprising a machine side surface layer is provided on the machine side surface of said core.

4. A dewatering fabric according to claim 3, wherein the paper contacting surface layer is relatively the finest of the layers, being composed of closely spaced yarns, fibers or particles of small diameter and the machine side surface layer is of intermediate fineness being composed of yarns, fibers or particles of a larger diameter and more loosely spaced than those of the paper contacting surface layer.

5. A fabric according to claim 3, wherein the core is composed of widely spaced yarns, fibers or particles, or of 8 perforated sheet or membrane layer.

6. A fabric according to claim 1 wherein regions of the fabric are treated to render said regions more, or less hydrophilic.

7. A dewatering fabric according to claim 2, comprising a core of a woven base cloth, a single or composite perforated membrane or a spiral-link base cloth, having a batt of staple fibers needled to each face of the base cloth.

8. A fabric according to claim 7 wherein the core is filled with a porous material.

9. A fabric according to claim 8, wherein said porous material filling the core comprises an open celled foam or a sintered plastics material.

10. A fabric according to claim 7, wherein the fibrous batt is coated with a resin and then perforated.

11. A fabric according to claim 2 wherein at least one layer of the fabric comprises a sintered structure formed from beads, fibers or other particles of thermoplastics or metal, partially melted and fused together.

12. A fabric according to claim 11 wherein the sintered structure further contains a textile reinforcement such as chopped fibers, a woven fabric felt, a non-woven fabric, membrane or yarns, at least partially encapsulated in the sintered structure.

13. A fabric according to claim 2 wherein at least one layer of the fabric comprises a microporous open cell foam coated structure.

14. A fabric according to claim 2 comprising a laminate of a sintered polymer, coating, fine staple batt layer or composite membrane on a core of a spiral link or open structure with a further fine layer of the same or different material as the upper layer on the underside.

15. A fabric according to claim 1, made from materials having high resistance to high temperature and hydrolysis, such as PPS, PEEK, PEK, polyamide, fluoropolymer, glass, metal, PEN or PBM.

16. A fabric according to claim 15 wherein less resistant materials are used in parts of the fabric which are at least partially insulated from the hot jet or roll by the high temperature resistant material, such as nylon, PET, PBT, PTT, PCTA or polyesteramides.

17. A fabric according to claim 2 wherein the surface layer and the core are constituted by a single structure providing zones of differing mean void volume.

18. A fabric according to claim 17 comprising a two-ply woven core zone of relatively coarse cross-machine direction or weft yarns and superposed thereon on the paper side of the fabric, a two-ply woven zone of relatively fine cross-machine direction or weft yarns.

19. A fabric according to claim 18 wherein the layers are interwoven by means of warp yarns which interlink the weft yarn plies into a single woven structure.

20. A fabric according to claim 18 comprising a further ply of finer weft yarns on the cylinder side of the core zone which are bound into the weave structure by warp yarns which pass about the further yarns and the lower ply of the core yarns.

21. A fabric according to claim 17 wherein the core zone comprises a single ply of larger diameter weft yarns.

22. A fabric according to claim 2 comprising a relatively fine woven layer laminated to the paper side of a perforated membrane of synthetic plastics material or resin impregnated fibrous material.

23. A fabric according to claim 22 wherein the perforations of the membrane are tapered with their wider ends adjacent the fine woven layer, and their narrower ends opening from the surface of the membrane at the cooling cylinder side.

24. A fabric according to claim 23 wherein the tapering perforations comprise two notional zones of different void volume, the wider ends forming a core zone of greater void volume, and the narrower ends a cylinder side zone of lower void volume.

25. A fabric according to claim 22 wherein the perforations are stepped.

26. A fabric according to claim 2, which comprises a structure of sintered particles bonded together by fusion over contact zones, with interstices between the particles, the structure providing a core zone of relatively large particles with large spaces between them and an outer zone on the paper side with relatively fine particles defining a paper contacting surface.

27. A fabric according to claim 26 comprising a further zone on the cylinder side, of relatively fine particles which define a cylinder contacting surface, these zones being created by laying down different sized particles as the structure is built up.

28. A fabric according to claim 26 wherein the zones are merged by transition regions wherein the particle size decreases towards the respective surface.

29. A fabric according to claim 26 wherein the structure of sintered particles includes reinforcing fibers.
